(19) United States
(12) Patent Application Publication
(10) Pub. No.: US 2025/0098695 A1
(43) Pub. Date: Mar. 27, 2025

(54) PLANT-BASED BUTTER

(71) Applicant: AAK AB (publ), Malmo (SE)

(72) Inventors: Jeffrey B. FINE, Malmo (SE); Binu Z. EAPEN, Malmo (SE); Jackie S. STEFFEY, Malmo (SE)

(21) Appl. No.: 18/728,192

(22) PCT Filed: Jan. 26, 2023
(86) PCT No.: PCT/SE2023/050069

§ 371 Date: Jul. 11, 2024

(30) Foreign Application Priority Data
Jan. 26, 2022 (SE) 2230022-2

(51) Int. Cl. A23D 7/005; A23D 7/01; C11C 3/10

(52) U.S. Cl. CPC A23D 7/0056; A23D 7/013; C11C 3/10

(57) ABSTRACT

A dairy analogue composition comprising a fat phase, an aqueous phase and an emulsifier, wherein the fat phase comprises interesterified coconut oil and wherein the dairy analogue composition is substantially free of hydrogenated fats and oils, more preferably, the dairy analogue composition is free of hydrogenated fats and oils.

### FIELD OF INVENTION

The present invention relates to a dairy analogue composition comprising a fat phase, an aqueous phase and an emulsifier, and the use of said dairy analogue composition in food products. In particular, the invention relates to the use of certain fat phases in dairy analogue compositions to improve various properties of the dairy analogue compositions.

### BACKGROUND OF THE INVENTION

There is a rapidly growing demand for plant-based foods due to consumers' increasing desire to eat healthy, sustainably sourced food products and to generally lower their meat and dairy intake. One cause of this trend in consumer habits is the growing populations of vegans, who require food products to be completely absent of animal-derived products for ethical and health reasons.

This has led to the development of various plant-based food products such as plant-based meats (meat analogue compositions) and plant-based dairy (dairy analogue compositions) which aim to mimic certain qualities of animal-derived products, such as texture, taste and appearance. Plant-based analogues for various dairy applications such as ice cream, cheese, butter and spreads are increasingly known. The inventors of the present invention have appreciated that there is a need for plant-based butters and spread analogues that are improved over the current state of the art.

To be suitable for use as a plant-based butter or spread, dairy analogue compositions must have properties which mimic traditional dairy based products, including structure retention, good spreadability and lack of oil separation, with all attributes being important to consumers. For consumers, spreadability is the ease by which a product can be spread and is an especially important parameter in spreads, margarines, butters and other foods such as creams and cream cheese. Therefore, the selection of the fat phase within the dairy analogue composition is important for the achievement of the desired effects.

Unfortunately, many fats derived from plants have low melting points. Vegetable oils are rich in unsaturated or polyunsaturated fats, whereas animal fats are rich in saturated fats. Saturated fats typically have much higher melting points than unsaturated fats.

Low melting point vegetable oils and fats used in plant-based dairy products, such as plant-based butter, have been found by the inventors of the present invention to be functionally limited and undesirable. Specifically, it has been found that upon removal from the refrigerator for a short time, the vegetable oil present therein melts and separates from the matrix of the product. This defect is known as “oiling out” to those skilled in the art. This results in, for example, plant-based dairy compositions such as spreads losing their structure and oiling-out. In some instances the products look entirely melted, even at room temperature. It will also be appreciated that such products are considered to have an entirely unattractive appearance and are considered undesirable by consumers.

Typically, plant-based dairy products such as butters and spreads comprise fractions (for example stearin fractions) of palm oil or palm kernel oil with the specific purpose of providing ‘hardstock properties’, which are able to provide a crystal lattice structure and entrain oil. Typically, the term “hardstock” refers to a fat that is solid at room temperature or higher (for example margarine hardstocks generally melt at temperatures of 44 to 49.5° C.). The hardstock may comprise two or more different hard fats, but is preferably a single fat. However, single, natural vegetable non-modified fats which are suitable as hardstocks are generally rare.

Palm or palm kernel oil fractions are often used to give the plant-based dairy analogue the sensory and functional properties of animal-derived products. Palm or palm kernel oil fractions have a high melting point (approximately up to 49.5° C.) and the capacity to entrain liquid oil which give the product structure and spreadability, even at room temperature.

However, the use of palm or palm kernel oils has many associated disadvantages, particularly the negative environmental effects associated with their production. To overcome this, the industry has sought to move away from the use of palm oils and palm kernel oils.

As an alternative to the use of palm or palm kernel oils, coconut oil has been proposed. Coconut oil is plant derived and so fulfils the criteria for being suitable for use in vegan food products.

However, coconut oil has a melting point of 24° C., and so whilst it has a higher melting point than many other vegetable derived oils (such as sunflower oil) and so has the potential to mimic the properties of animal-derived fats, its melting point is significantly less than the palm oil fractions (palm stearin is approximately 55° C.) and melts faster (i.e. has a steeper melting curve) so coconut oil fails to provide suitable crystal lattice structure and lacks the ability to entrain liquid oil to fully mimic real dairy products at or above room temperature. That is, the physical properties of coconut oil make it unsuitable for use in many applications. It will be appreciated that these physical properties also include brittleness at low temperatures as well as the rapid loss of structure at temperatures above the melting point (which itself is significantly below body temperature).

As a result, the use of coconut oil, in commercial dairy products, especially plant-based butter, demonstrates certain negative effects and disadvantages. In such products (and as shown in the examples below) the coconut oil has a tendency to oil out, i.e., the liquid oil separates from the products at room temperature thus resulting in a loss of structure, and accordingly poor visual effects and poor spreadability. They also exhibit limited thermal stability and are prone to melting when removed from the refrigerator, even for only a short time.

An approach for providing a harder, higher melting point fat for use in food products is to use a hydrogenated vegetable oil. Hydrogenation increases the saturated fatty acid moiety content of the oil and thus increases its melting point. Hydrogenation can be done either partly (thus leaving some unsaturated fatty acids present in the fat) or fully where 100% (or near) of the unsaturated fatty acid moieties present in the oil are converted to saturated fatty acids. However, a disadvantage of using partially hydrogenated fats is that they contain a high content of trans unsaturated fatty acids, which has been linked to an increased incidence of heart disease and higher cholesterol in consumers, amongst other conditions. A further disadvantage of using fully hydrogenated fats is that the resulting composition typically has a poor melting behaviour resulting in an undesirable and unpleasant “waxy” mouth feel when included in food products, such as dairy analogue compositions. Consumers are also increasingly health conscious and are wary of foods that contain hydrogenated fats.

An alternative approach (which also allows palm and palm kernel to be avoided as ingredients) has been to blend low melting point fats and oils with those of higher melting point, or to subsequently interesterify those blends. By way of example shea butter (approx. 35° C.), shea stearin (approx. 60° C. and shea olein (approx. 29° C.). Others with higher melting points include illipe (approx. 36° C.), sal (approx. 31° C.), kokum (approx. 39° C.) and mango kernel (approx. 40° C.). By interesterifying the blended fats, it is possible to obtain a bulk fat which maintains its physical properties over a wider temperature range and without concern regarding separation of the components and issues such as oiling out.

However, there remains a need in the art for improved dairy analogues suitable for producing food products such as spreads and butter substitutes, and which have suitable sensory and organoleptic properties, and which avoid unfavourable issues in the art such as oiling out and loss of structure (and the use of palm/palm kernel fractions and/or hydrogenation).

### SUMMARY OF THE INVENTION

The present invention is based on the surprising finding that fat phases containing interesterified coconut oil are excellent hardstocks and are suitable for use in dairy analogue compositions. Surprisingly, it has been found that dairy analogues comprising interesterified coconut oil display many advantages over known fats such as coconut oil, palm oil and palm kernel oil, without the need for hydrogenation or more complicated blending and processing required by other solutions.

When used in butter and spread analogue compositions, the dairy analogue of the invention imparts certain advantages over analogous compositions containing palm or palm kernel oil, coconut oil or hydrogenated oils, or interesterified blends in the state of the art. The butter and spread compositions formed from the dairy analogue compositions of the present invention exhibit good spreadability, minimal oiling out, structure retention and good thermal stability. As discussed below in the Examples, the inventors surprisingly found that plant-based spreads made with interesterified coconut oil are able to consistently out-perform current products on the market. Many of such commercially available spreads contain coconut oil and have a high tendency to slump, melt and oil out, especially when removed from refrigeration temperatures for even short periods of time. Therefore, it has also been surprisingly found that interesterified coconut oil can be used to improve the properties of plant-based spreads. This is particularly surprising as coconut oil itself has a triglyceride composition which is dominated by the presence of fully saturated triglycerides, for example about 84% SSS, 12% SUS and 4% UUS (where S=saturated and U=unsaturated). The presence of a disproportionately high amount of SSS means that there is very low triglyceride diversity. This distinct lack of triglyceride diversity also means that there is no apparent benefit to modification of coconut oil itself, such as by interesterification. However, as discussed herein, the present inventors have surprising found that an interesterified coconut oil provides properties which are entirely unexpected despite known chemical and physical limitations such as described above.

As the compositions are substantially free of palm and palm kernel oil, or oils derived thereof, as well as being free of hydrogenated oils, the associated problems are avoided. The fat phases are free of trans unsaturated fatty acids, meaning that said compositions are considered healthier than compositions containing partially hydrogenated oils. Indeed, it is particularly beneficial to be able to avoid the use of hydrogenated fats and oils (e.g. partially hydrogenated) and their high content of trans unsaturated fatty acids, which have been linked to an increased incidence of heart disease and higher cholesterol in consumers, amongst other conditions. The compositions also avoid the undesirable and unpleasant “waxy” mouthfeel associated with the poor melting behaviour of fully hydrogenated vegetable fats and oils. As a result, these fat phases can be effectively used in dairy analogue compositions, such as for plant-based butter. More generally, It is similarly beneficial to avoid the use of fully hydrogenated fats with respect to consumers who are increasingly health conscious and are wary of foods that contain hydrogenated fats.

Pure coconut oil is not routinely interesterified in this field or any other due to the lack of obvious benefits for doing so. Rather, where used, coconut oil is blended with fats and oils of higher melting point or interesterified with the fats and oils of higher melting point to yield a hardstock fat component.

However, the present inventors have noted that, for the use in plant-based spreads, interesterified coconut oil offers surprising tangible benefits, particularly which respect to hardstock properties.

According to a first aspect of the invention, there is provided a dairy analogue composition. The dairy analogue composition comprises a fat phase, an aqueous phase and an emulsifier, wherein the fat phase comprises interesterified coconut oil and wherein the dairy analogue composition is substantially free of hydrogenated fats and oils, more preferably, the dairy analogue composition is free of hydrogenated fats and oils. The fat phase preferably comprises interesterified coconut oil mixed with a liquid vegetable oil.

The term “fat” as used herein refers to glyceride fats and oils containing fatty acid acyl groups and does not imply any particular melting point. The term “oil” is used synonymously with “fat” herein.

The term “fatty acid”, as used herein, refers to straight chain saturated or unsaturated (including mono- and poly unsaturated) carboxylic acids having 4 to 24 carbon atoms. A fatty acid having x carbon atoms and y double bonds may be denoted Cx:y. For example, palmitic acid may denote C16:0, oleic acid may denoted C18:1. Percentages of fatty acids in compositions referred to herein include acyl groups in tri-, di- and mono-glycerides present in the glycerides and are based on the total weight of C6 to C24 fatty acids. The fatty acid profile (i.e. composition) may be determined, for example, by fatty acid methyl ester analysis (FAME) using gas chromatography according to IUPAC 2.304.

Triglyceride content may be determined for example based on molecular weight differences (Carbon Number (CN)) by AOCS Ce 5-86. The notation triglyceride CNxx denotes triglycerides having xx carbon atoms in the fatty acyl groups, e.g. CN54 includes tristearin. Amounts of triglycerides specified with each carbon number (CN) as is customary terminology in the art are percentages by weight based on total triglycerides of CN26 to CN62 present in the fat composition.

The coconut oil used in the present invention may be generally any known coconut oil (i.e. derived from Cocos nucifera). A particular advantage of the present invention is that the coconut oil does not require any specialised processing such as fractionation or hydrogenation in order to obtain the improved results, such as those exemplified below.

References in the present application to coconut oil and interesterified coconut oil are preferentially to pure coconut oil, i.e., the coconut oil has not been blended with non-coconut oils prior to interesterification.

It will of course be appreciated that any composition consisting essentially of interesterified coconut oil would be suitable, as well as compositions consisting of interesterified coconut oil.

Interesterification can be defined as the redistribution of the fatty acid moieties present in the triglyceride molecules that make up an oil. Interesterification is generally considered a cost effective and simple method that can be used for modifying the functionality of fats and oils, especially compared with fractionation, which is more complex and generates further side streams. A “fully interesterified” oil is understood as an oil that has a completely randomised arrangement of fatty acid moieties. The randomised arrangement of fatty acid moieties can be determined using high-performance liquid chromatography (HPLC) and/or gas liquid chromatography (GLC) with comparison to the starting oil.

The interesterified coconut oil may be produced by chemical interesterification, enzymatic interesterification, or a combination thereof. In general, it is preferred that the interesterified coconut oil is fully interesterified. However, it will be appreciated that enzymatic interesterification may be used where it is desired to have greater reaction control and specificity.

Any suitable interesterification process known in the art can be used to produce the interesterified coconut oil component. For example, the interesterification process conditions discussed in EP2196094 can be used.

A further advantage of the present invention is the fact that the interesterification process is undertaken on an unfractionated coconut oil, so as to prevent further complex procedures being required and to lower the cost of the interesterified coconut oil.

Also, in accordance with the dairy analogues of the present invention, the interesterified coconut oil of the fat phase may be blended with other vegetable oils, preferably liquid vegetable oils. It is believed that the interesterified coconut oil of the fat phase being an excellent hardstock is capable of retaining liquid oil preventing oiling out.

By way of example, the fat may comprise from 25% to 100% by weight of the fat phase of interesterified coconut oil mixed with from 0% to 75% by weight of the fat phase of vegetable oil. Preferably, the fat phase may comprise from 40% to 90% by weight of the fat phase of interesterified coconut oil mixed with from 10% to 60% by weight of the fat phase of vegetable oil. More preferably the phase may comprise from 60% to 85% by weight of the fat phase of interesterified coconut oil mixed with from 15% to 40% by weight of the fat phase of vegetable oil.

In practice, it will be appreciated that a person of skill in the art is able to control and alter the relative amounts of interesterified coconut oil and vegetable oil to provide desired properties in the resulting dairy analogue composition. For example, the relative amounts of each component can be used to control the solid fat content (SFC) of the fat phase, for example, if a higher SFC is desired, a greater relative amount of interesterified coconut oil may be added.

As will be appreciated by those of skill in the art, the solid fat content (SFC) is the percentage of solids within the fat at a specified temperature. The SFC of a fat phase is known to affect many important physical and sensory properties, such as texture, structure, consistency and visual appearance, for example the difference between tub margarines and stick margarines. SFC is, accordingly, an important attribute of fats and oils that determines the utility of individual fats or blends in various applications. SFC values help to determine the spreadability of a product at different temperatures, the thermal stability of a product and resistance to oiling out, as well as the mouth feel of the fat. In the context of the present invention, and without wishing to be bound by any particular theory, it has surprisingly been found that the SFC of interesterified coconut oil is such that it is possible to obtain a dairy analogue composition having superior structure and spreadability, as well as a reduced tendency to oil out, especially when used in plant-based spreads and butter. This is unexpected because interesterified coconut oil has a melting point far lower than typical hardstocks employed for margarine and spread production.

The vegetable oil of the fat phase can in principle be any suitable vegetable oil. Suitable oils include those that are liquid below 20° C., such as below 15° C., 10° C. and even 5° C.

Preferably, the vegetable oil may be selected from rapeseed oil, high oleic rapeseed oil, high erucic acid rapeseed oil, soybean oil, sunflower oil, high oleic sunflower oil, linseed oil, olive oil, corn oil, cottonseed oil, carinata oil, groundnut oil, safflower oil, high oleic safflower oil, peanut oil, avocado oil, rice oil, camelina oil, or any combination thereof.

In some instances, it is preferable for the vegetable oil to be selected from a trait enhanced oil such as high oleic sunflower oil, high oleic safflower oil, high oleic rapeseed oil, or combinations thereof, due to their higher oxidative stability.

It will be appreciated that the vegetable oils, for example liquid vegetable oils, are not interesterified.

In some examples, the dairy analogue composition may comprise substantially of fat with relatively less aqueous phase (i.e., the fat phase comprises substantially of fat molecules).

However, in other examples, the dairy analogue composition may comprise increased amounts of aqueous phase and be in the form of an emulsion such as a water-in-oil emulsion.

The dairy analogue compositions of the present invention may comprise up to 65% by weight of an aqueous phase, preferably in an amount of 10% to 50% by weight, more preferably in an amount of 15% to 25% by weight.

The aqueous phase may comprise of any edible aqueous medium, for example, water, a plant-based milk alternative, a plant-derived water, or combinations thereof.

Plant-based milks are plant-based beverages generally having a colour resembling that of milk. Such plant-based milks are non-dairy and produced from water-based plant extracts for flavouring and aroma. These milks are also considered plant-based alternatives to dairy milk, at least in part, due to their creamy mouthfeel. Any suitable plant-based milk alternative may be used as part of the aqueous phase of the dairy analogue. Preferably the plant-based milk alternative is derived from cereal (such as oat, rice, corn or spelt), legume (such as soy, peanut, lupin or cow pea), nut (such as almond, coconut, hazelnut, cashew, pistachio or walnut), seed (such as sesame, flax, hemp or sunflower), pseudo-cereal (such as quinoa, teff or amaranth), or any combination thereof.

Plant-based waters are aqueous compositions directly extracted from plants. Any suitable plant-based water may be used as part of the aqueous phase of the dairy analogue. Preferably, the plant-based water is derived from coconut water, maple water, birch water, aloe vera water, cactus water, watermelon water, artichoke water, almond water, or any combination thereof.

With respect to weight percentages for the amount of the aqueous phase which may be present in the dairy analogue compositions, the weight percentages refer to both aqueous media added in its own right during manufacture of the dairy analogue composition, and also to any aqueous media present in other components of the dairy analogue composition (such as any water present in an emulsified fat phase).

The aqueous phase can generally be added to the dairy analogue in any suitable amount, and it will be appreciated that the amount to be added is dependent upon the intended use of the dairy analogue composition. As would be known by those of skill in the art, the amount of aqueous phase added may be used to control the nutritional and/or physical properties of the dairy analogue, and thus allow for optimisation of such physical properties depending on the intended use of the dairy analogue. For example, increasing the amount of aqueous phase, lowers the caloric density of the composition.

The dairy analogue compositions of the present invention may be used to produce foodstuffs such as cheeses (for example hard, soft and cream cheeses), creams, whipped creams, butter and spread analogues, and frozen desserts. Butter and spread analogues are most preferred.

The dairy analogue composition also comprises one or more emulsifiers. Preferably, the emulsifiers are present in an amount of up to 8% by weight of the dairy analogue composition.

In some examples, the one or more emulsifiers may be present in an amount of 3 to 5% by weight of the dairy analogue composition.

In other examples, the one or more emulsifiers may be present in an amount of up to 2% by weight of the dairy analogue composition, preferably up to 1% by weight of the dairy analogue composition.

Any suitable emulsifier may be used in the dairy analogue compositions of the present invention. Examples of suitable emulsifiers include proteins (such as pea), phospholipids (such as lecithin), mono- and diglycerides, or combinations thereof.

Where the emulsifier is a protein, it is generally preferable that it be added in an amount of up to 8% by weight of the dairy analogue composition, preferably 3 to 5% by weight of the dairy analogue composition.

Where the emulsifier is a phospholipid, it is generally preferable that it be added in an amount of up to 2% by weight of the dairy analogue composition, preferably up to 1% by weight of the dairy analogue composition.

Where the emulsifier is mono- and diglycerides, it is generally preferable that it be added in an amount of up to 2% by weight of the dairy analogue composition, preferably up to 1% by weight of the dairy analogue composition.

The dairy analogue compositions of the present invention may further comprise one or more colour additives in an amount of 0.001% to 1% by weight of the composition, preferably in an amount of 0.01% to 0.1% by weight.

Preferably, the colour additives are derived from fruit, vegetables or edible plants. A benefit of the use of such colour additives is that they are vegan-friendly.

The dairy analogue compositions of the present invention may also comprise one or more flavourings in an amount of 0.1% to 5% by weight of the composition, preferably in an amount of 1% to 2% by weight.

Other additives that can be included will be familiar to the skilled person and may include preservatives, sweeteners, salts, bulking agents, and other additives known in the art for inclusion in such compositions.

It is preferable that the dairy analogue compositions of the present invention be suitable for consumption by vegetarians and vegans. Accordingly, in preferred embodiments, the dairy analogue compositions are substantially free of animal protein, and more preferably, the dairy analogue compositions are free of animal protein.

It is also likewise preferable for the dairy analogue compositions of the present invention to be substantially free of animal-derived products, and more preferably, free of animal derived products.

In preferred embodiments, the dairy analogue composition is substantially free of palm and palm kernel oils, and oils derived therefrom. Preferably, the dairy analogue composition is free of palm and palm kernel oils, and oils derived therefrom. It is of course particularly beneficial to be able to avoid the use of palm oil, palm kernel oil, and derivatives thereof particularly due to the negative environmental effects associated with its production.

In preferred embodiments, the dairy analogue composition comprises a fat phase that has a Solid Fat Content (SFC) at 25° C., N25, of greater than 1 according to ISO 8292-1, preferably, wherein the fat phase has a Solid Fat Content (SFC) at 25° C., N25, of greater than 2 according to ISO 8292-1.

According to a second aspect of the invention, there is provided a method of preparing the dairy analogue composition as described above, wherein the method comprises mixing a fat phase comprising interesterified coconut oil, an aqueous phase and an emulsifier.

As noted above, the interesterified coconut oil may be obtained by chemical interesterification, or enzymatic interesterification.

The dairy analogue compositions may be prepared using known means which would be readily apparent to those of skill in the art. By way of example, the diary analogue may be prepared using a scraped-surface heat exchanger (well known in this field and to those of skill in the art), which generally comprises the following steps:
1. Preparation of a fat phase and an aqueous phase;
2. Blending the fat phase and aqueous phase with constant agitation at a temperature at which the interesterified coconut oil is liquid such that an emulsion is formed;
3. Cooling the mixture under high shear with a scraped surface heat exchanger to induce crystallization of the interesterified coconut oil to stabilise the emulsion and provide the product some degree of firmness; and
4. Modification of the crystal network (such as by means of a pinworker) to produce the desired firmness, confer plasticity and reduce the water droplet size.

These steps are usually conducted in a process that involves apparatuses that provide heating, cooling and mechanical working of the ingredients.

According to a third aspect of the invention, there is provided a food product comprising a dairy analogue composition according to the first aspect of the invention. Such food products are generally those which would be produced using dairy derived fats and oils. By way of example, the food products may include cheeses (for example hard, soft and cream cheeses), creams, whipped creams, or butter and spread analogues.

In a preferred embodiment, the food product is a butter substitute. The term butter substitute is intended to refer to alternative compositions which can be used instead of butter.

In a further preferred embodiment, the food product is a spread. The term spread generally refers to spreadable food products containing less than 80% by weight of fat. The term spread has also become synonymous with margarines, although technically margarines comprise at least 80% by weight of fat.

A benefit of the dairy analogue compositions described herein is that they preferably allow for the production of food products which are vegetarian or vegan dairy substitute food products, such as a vegan butter substitute.

The properties of the food products (and indeed the dairy analogue compositions) prepared may be measured by any suitable means. Properties of interest may include hardness, adhesiveness, mouth feel and spreadability. Of particular interest in the present invention is the spreadability, shape retention and oil separation.

The performance properties of a butter, margarine, spread or dairy analogue can be described by its firmness and spreadability. Firmness (or hardness) is the force required to deform the product. Spreadability, likely the most important attribute from a consumer point of view, refers to the force required to spread or shear the product. Firmness and spreadability are strongly correlated, but the relationship is not a perfect one.

The firmness of a composition or food product can be measured by penetrometry using an appropriately chosen probe (e.g. puncture probe).

Spreadability of a composition or food product may be measured using known specialized equipment such as the TTC spreadability rig (Stable Micro Systems). The TTC spreadability rig comprises a set of precisely matched male and female Perspex 90-degree cones. The composition, or food product, is allowed to set in or filled into the lower (female) cone and gently compressed so as to eliminate any air products prior to the test. During the test procedure, spreading occurs, when a defined force is applied and the product is squeezed out from between the male and female cones and caused to flow outward. The total amount of force required to cause this outward flow is the work-shear and is a measure of spreadability.

In preferred embodiments of the present invention, the food product has a spreadability at 3° C. of from about 5 kg·sec to about 125 kg·sec, preferably of from about 10 kg·sec to about 50 kg-sec. It will be appreciated that the spreadability may be determined according to the desired end use.

Alternatively, or in addition, the food product preferably has a spreadability at 22° C. of from about 0.3 kg·sec to about 16.0 kg·sec, preferably from about 0.5 kg·sec to about 5 kg-sec.

According to a fourth aspect of the invention, there is provided the use of a fat phase in a dairy analogue composition, wherein the fat phase comprises interesterified coconut oil mixed with a vegetable oil, the vegetable oil being present in an amount of up to 65% by weight of the fat phase and wherein the fat phase used is substantially free of hydrogenated oils, more preferably, the fat phase is free of hydrogenated oils.

Preferably, the use comprises using the dairy analogue composition in a food product.

Preferably, the dairy analogue composition, fat phase and/or food product are as described above in accordance with the aspects of the invention.

In preferred embodiments, the fat phase used is substantially free of palm and palm kernel oils, and oils derived therefrom. Preferably, the fat phase is free of palm and palm kernel oils, and oils derived therefrom.

According to a fifth aspect of the invention, there is provided a process of manufacturing a food product comprising use of a dairy analogue composition as described above.

### DESCRIPTION OF THE DRAWINGS

FIG. 1 compares the spreadability of butter analogue compositions (at 22° C. and 3° C.) in accordance with the present invention comprising interesterified coconut oil (A and C), a comparative butter analogue composition comprising coconut oil (B), and commercially available alternatives. The left y-axis is at 3° C. and the right y-axis is at 22° C.

FIG. 2 compares the spreadability of butter analogue compositions (at 22° C. and 3° C.) in accordance with the present invention comprising interesterified coconut oil (F), a comparative butter analogue composition comprising coconut oil (I), and commercially available alternatives. Again, the left y-axis is at 3° C. and the right y-axis is at 22° C.

FIG. 3 shows the results of Samples D-I from Example 2 being kept at a temperature of 22° C.

FIG. 4 depicts the spreadability of various butter analogue compositions (at 22° C. and 3° C.) in accordance with the present invention comprising interesterified coconut oil (Q, U, Y and Z), as well as comparative commercially available alternatives. Again, the left y-axis is at 3° C. and the right y-axis is at 22° C.

FIG. 5 shows the results of a range of butter analogue compositions (in accordance with the present invention, commercial, and comparative coconut compositions) being kept at a temperature of 22° C. FIG. 5A shows the compositions at the beginning of the experiment and FIG. 5B shows the compositions after they have been left at 22° C.

### DETAILED DESCRIPTION OF THE INVENTION

The following examples are for illustrative purposes only and are not intended to limit the scope of the invention in any way.

### Example 1

Three fat phases were prepared as follows:
Fat phase A comprising 100% interesterified coconut oil;
Fat phase B comprising 75% by weight regular coconut oil and 25% by weight of high oleic sunflower oil; and
Fat phase C comprised 75% by weight interesterified coconut oil and 25% by weight of high oleic sunflower oil.

These fat phases were used to make butter analogue compositions by the addition of water, an emulsifier and flavouring to provide the plant-based butters as shown below in Table 1.

TABLE 1

| | A | B | C |
|---|---|---|---|
| Coconut oil | 0 | 60 | 0 |
| Interesterified | 80 | 0 | 60 |
| Coconut Oil | | | |
| High Oleic | 0 | 20 | 20 |
| Sunflower Oil | | | |
| Water | 17.6 | 17.6 | 17.6 |
| Salt | 1.5 | 1.5 | 1.5 |
| Distilled | 0.5 | 0.5 | 0.5 |
| Monoglycerides | | | |
| Soy Lecithin | 0.3 | 0.3 | 0.3 |
| Sodium Benzoate | 0.1 | 0.1 | 0.1 |
| Natural Butter | 0.0072 | 0.0072 | 0.0072 |
| Flavour | | | |
| Beta Carotene | 0.0034 | 0.0034 | 0.0034 |
| Vitamin A palmitate | 0.0033 | 0.0033 | 0.0033 |

The oil blend was heated to 52° C. The distilled monoglyceride was melted to 82° C. and blended into the oil blend. The remaining oil soluble components were mixed into the oil blend. The water-soluble components were blended into potable city water. The water blend was added to the oil blend in the designated tank. The tank is water jacketed and equipped with an agitator to create the water-in-oil emulsion.

Butter analogue compositions A-C were made using a Margarine and Shortening Pilot Plant manufactured by Chemtech International Ltd. a division of TMCI Padavon Headquartered in Vittorio Veneto, Italy. The equipment consists of two scraped surface heat exchangers in sequence (C1 and C2) followed by a pin worker (W1). The scraped surface heat exchangers are chilled using Freon refrigerant cooled to −10° C. The shaft of the SSHE contains two blades and rotates at 450 rpms. The shaft of the pin worker rotates at 150 rpms. The compositions were processed under the following conditions (see Table 2 below):

TABLE 2

| | Tank | Agitator | Flow | C1-Unit Exit | C2-Unit Exit | W1-Unit Exit | Filling | Back |
|---|---|---|---|---|---|---|---|---|
| | Temperature | Speed | Rate | Temperature | Temperature | Temperature | Temperature | Pressure |
| Sample | (° C.) | (RPM) | (lbs/hr) | (° C.) | (° C.) | (° C.) | (° C.) | (psi) |
| A | 52 | 250 | 300 | 30.5 | 21.1 | 25 | 26.1 | 57 |
| B | 49 | 250 | 350 | 25.5 | 15.5 | 20 | 20.5 | 81 |
| C | 49 | 250 | 300 | 25 | 17.8 | 21.7 | 22.2 | 86 |

Sample containers were stored at 22° C. and 3° C. and measured for penetration and spreadability using a TA.XTPlus Texture Analyzer from Stable Micro Systems, Ltd as follows:

### Penetration

| | |
|---|---|
| Instrument | TA.XTPlus Texture Analyzer from Stable Micro Systems, |
| | Ltd. |
| Method | Margarine and Solid Shortening Penetration - MAR1_P5 |
| Probe | TA-24 (1/4″ diameter) |

Penetration was measured at 22° C. (72° F.) and 3° C. (38° F.) on a Texture Analyzer (TA.XT plus).
A 6.35 mm (¼ in) cylinder probe was pressed 12.0 mm into an undisturbed sample. The test speed was 2.0 mm/sec.

### Firmness/Spreadability

| | |
|---|---|
| Instrument | TA.XTPlus Texture Analyzer from Stable Micro Systems, |
| | Ltd. |
| Method | Vegetable Extract Spread - SPRD1_SR |
| Probe | TA-425 - TCC Spreadability Rig |

Firmness and spreadability were measured at 22° C. (72° F.) and 3° C. (38° F.) on a Texture Analyzer (TA.XT plus). Precisely matched male and female Perspex 90° cones. Material is placed in lower female cone and leveled. Material is pressed only so much as is needed to eliminate air pockets.
The test speed was 3.0 mm/sec.

Effectiveness of the compositions was determined through visual observation at 22° C. Results were compared to retail samples of butter and plant-based butter stored at identical temperatures.

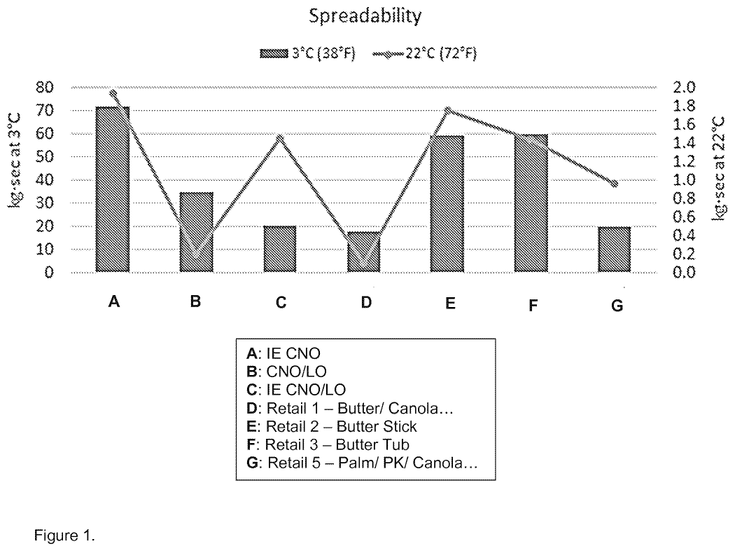

The results of the analysis are shown in Table 3 below, as well as FIG. 1.

TABLE 3

| Sample | Penetration | Firmness | Spreadability - | Visual Oil |
|---|---|---|---|---|
| (analysed at | (grams of force) - | (kg of | Work of Shear | Separation |
| 22° C.) | average | force) | (kg · sec) | at 22° C. |
| A | 814.06 | 1.77 | 1.93 | None |
| B | 15.62 | 0.23 | 0.2 | Heavy |
| C | 212.32 | 1.02 | 1.45 | None |
| Retail 1 | 10.03 | 0.13 | 0.11 | Slight |
| (Butter/Canola Spread) | | | | |
| Retail 2 | 48.09 | 1.62 | 1.75 | None |
| (Butter Stick) | | | | |
| Retail 3 | 46.59 | 1.42 | 1.44 | None |
| (Butter Tub) | | | | |
| Retail 4 | 164.83 | 1.41 | 1.48 | None |
| (PK/Palm/Sunflower PB | | | | |
| Butter Block) | | | | |
| Retail 5 | 21.24 | 0.97 | 0.96 | Heavy |
| (Palm/PK/Canola PB | | | | |
| Butter Stick) | | | | |
| Retail 6 | NA | 0.01 | 0 | Heavy |
| (Sunflower/CNO PB Butter | | | | |
| Spread) | | | | |
| Retail 7 | NA | 0.03 | 0.02 | Heavy |
| (Sunflower/CNO PB Butter | | | | |
| Spread) | | | | |
| Sample | Penetration | Firmness | Spreadability - | Visual Oil |
| (analysed at | (grams of force) - | (kg of | Work of Shear | Separation |
| 3° C.) | average | force) | (kg · sec) | at 3° C. |
| A | 9576.56 | 41.33 | 71.7 | None |
| B | 4211.24 | 19.65 | 34.8 | None |
| C | 2694.80 | 13.31 | 20.41 | None |
| Retail 1 | 362.35 | 10.59 | 17.81 | None |
| (Butter/Canola Spread) | | | | |
| Retail 2 | 2830.39 | 33.46 | 58.93 | None |
| (Butter Stick) | | | | |
| Retail 3 | 1407.36 | 31.93 | 59.86 | None |
| (Butter Tub) | | | | |
| Retail 4 | 2353.19 | 16.55 | 27.77 | None |
| (PK/Palm/Sunflower PB | | | | |
| Butter Block) | | | | |
| Retail 5 | 21.24 | 12.27 | 19.81 | None |
| (Palm/PK/Canola PB | | | | |
| Butter Stick) | | | | |
| Retail 6 | 866.00 | 5.77 | 8.61 | None |
| (Sunflower/CNO PB Butter | | | | |
| Spread) | | | | |
| Retail 7 | 972.76 | 6.33 | 8.88 | None |
| (Sunflower/CNO PB Butter | | | | |
| Spread) | | | | |

Sample A, containing interesterified coconut oil, has a comparable spreadability to Retail 2 and Retail 3, i.e. real dairy butters at 22° C. Sample C, containing interesterified coconut oil mixed with sunflower oil, had a comparable spreadability at 3° C. to Retail 1, which is a butter and canola spread, and Retail 5, which is a palm and palm kernel-based spread, but showed an increased spreadability at 22° C. Retail 1 showed oil separation at 22° C., whereas Sample C did not exhibit any oil separation. Sample C also has a lower spreadability than Retail 2 and 3 at 3° C., meaning that it is easier to spread, even straight out of the refrigerator.

Both Sample A and Sample C showed significantly improved spreadability (more structure) at 22° C. over Sample B, which contained a regular coconut oil and sunflower oil mixture. Sample B displayed heavy oil separation at 22° C. Retail 5 also showed heavy oil separation.

Thus, Samples A and C are not only comparable in spreadability with butter, they also avoid issues such as oil separation which plague known commercial products.

### Example 2

Six fat phases were prepared as follows:
Fat phase D comprised 100% interesterified coconut oil;
Fat phases E and F comprised 80% by weight interesterified coconut oil and 20% by weight of high oleic sunflower oil;
Fat phase G comprised 100% regular coconut oil; and
Fat phases H and I comprised 80% by weight regular coconut oil and 20% by weight high oleic sunflower oil.

Fat phases F and I were used to make butter analogue compositions by the addition of water, an emulsifier and flavouring to give the butter analogues with total constituent amounts as shown below in Table 4.

TABLE 4

| | D | E * | F * | G | H | I |
|---|---|---|---|---|---|---|
| Coconut Oil | 0 | 0 | 0 | 100 | 80 | 63.4 |
| Interesterified | 100 | 80 | 63.4 | 0 | 0 | 0 |
| Coconut Oil | | | | | | |
| High Oleic | 0 | 20 | 15.8 | 0 | 20 | 15.8 |
| Sunflower Oil | | | | | | |
| Water | 0 | 0 | 20 | 0 | 0 | 20 |
| Distilled | 0 | 0 | 0.5 | 0 | 0 | 0.5 |
| Monoglycerides | | | | | | |
| Soy Lecithin | 0 | 0 | 0.3 | 0 | 0 | 0.3 |

The compositions were prepared using a benchtop Cuisinart Ice Cream and Gelato Maker (ICE-100). The ice cream paddle was used to create a smooth texture. 1000-gram samples were heated to 49° C. The ice cream maker was chilled down for 15 minutes to −26° C. The sample was poured into the ice cream maker and churned for 15 to 20 minutes until the sample was solid. Samples were placed into 16 oz polypropylene containers and the spreadability cups and stored at the appropriate temperatures.

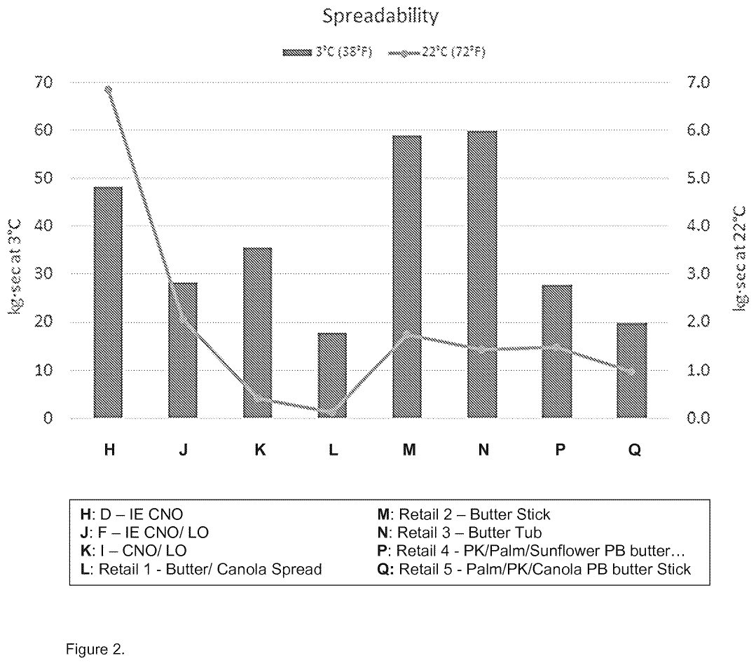

The compositions were stored and analysed as per Example 1, and are shown in Table 5 below, as well as FIG. 2.

TABLE 5

| Sample | Penetration | Firmness | Spreadability - | Visual Oil |
|---|---|---|---|---|
| (analysed at | (grams of force) - | (kg of | Work of Shear | Separation |
| 22° C.) | average | force) | (kg · sec) | at 22° C. |
| D | 442.19 | 4.83 | 6.85 | None |
| E * | 273.17 | 1.33 | 1.56 | Very slight |
| F * | 178.54 | 1.58 | 2.05 | Very slight |
| G | 417.39 | 2.78 | 3.85 | Heavy |
| H | 36.05 | 0.43 | 0.44 | Heavy |
| — | 11.88 | 0.42 | 0.42 | Heavy |
| Sample | Penetration | Firmness | Spreadability - | Visual Oil |
| (analysed at | (grams of force) - | (kg of | Work of Shear | Separation |
| 3° C.) | average | force) | (kg · sec) | at 3° C. |
| D | 9570.05 | 25.66 | 48.09 | None |
| E | 5401.57 | 13.88 | 25.21 | None |
| F | 4297.98 | 15.19 | 28.2 | None |
| G | 10445.89 | 33.24 | 65.95 | None |
| H | 4669.94 | 17.78 | 36.32 | None |
| — | 3260.22 | 19.95 | 35.55 | None |

As can be clearly seen in FIG. 2, Sample D, produced from 100% interesterified coconut oil, had a comparable spreadability at 3° C. to Retail 2 and Retail 3, both real butter, but displayed greater spreadability at 22° C. than those samples. Sample F, containing interesterified coconut oil blended with high oleic sunflower oil, showed comparable spreadability at 3° C. to Retail 4, which is a palm kernel and palm oil based spread. At 2200, Sample F showed comparable spreadability to Retail 2, 3 and 4, and superior spreadability to Retail 1 and 5.

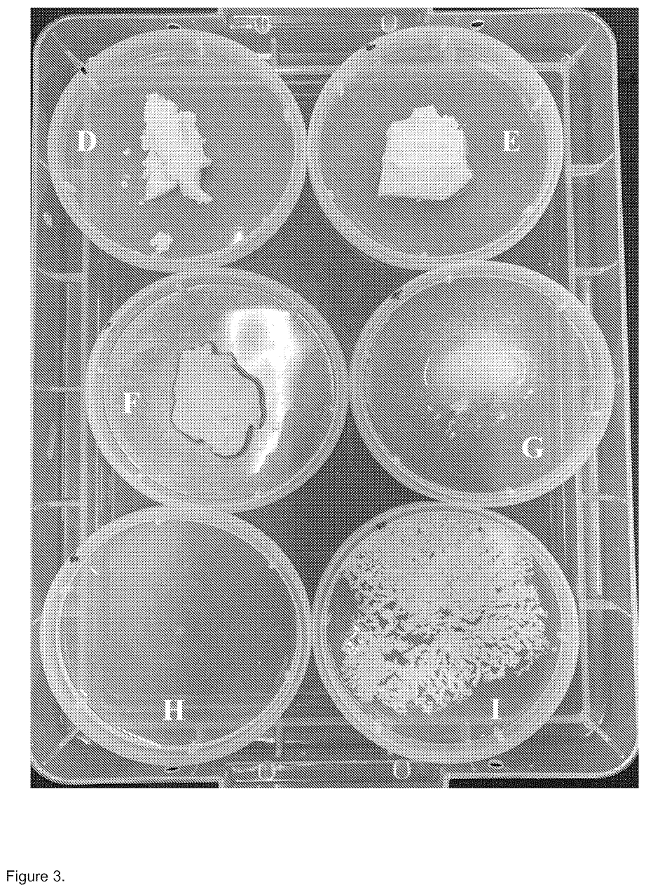

The Samples were left out at 22° C. to observe oil separation. Samples E and F (denoted with*) showed very slight visual oil separation at 2200, but considerably less than the compositions containing regular coconut oil (Samples G, H and 1), shown in FIG. 3.

The very slight oil separation for Samples E and F is believed to be a result of the samples being processed using a benchtop ice cream maker, rather than the Margarine and Shortening Pilot Plant. As shown in FIG. 3, this slight oil separation is however significantly less than the samples containing regular coconut oil and the samples still retained their structure. Sample I, containing regular coconut oil blended with high oleic sunflower oil, exhibited heavy oil separation at 22° C. Fat phases G and H also showed slumping, oiling out and melting when left at 22° C.

### Example 3

Four fat phases were prepared as follows:
Fat phases Q, U and Y all comprised 50% by weight interesterified coconut oil and 50% by weight of high oleic sunflower oil, and
Fat phase Z comprised 45% by weight interesterified coconut oil and 55% by weight of high oleic sunflower oil.

The butter analogue compositions were made using the same procedure as Example 2, and comprised the constituent amounts as shown below in Table 6.

TABLE 6

| | Q | U | Y | Z |
|---|---|---|---|---|
| Interesterified | 39.6 | 39.6 | 39.6 | 35.7 |
| Coconut Oil | | | | |
| High Oleic | 39.6 | 39.6 | 39.6 | 43.6 |
| Sunflower Oil | | | | |
| Water | 20 | 0 | 17 | 17 |
| Oat Milk | 0 | 20 | 0 | 0 |
| Distilled | 0.5 | 0 | 0 | 0 |
| Monoglycerides | | | | |
| Soy Lecithin | 0.3 | 0.73 | 0.73 | 0.73 |
| Pea Protein | 0 | 0 | 3 | 3 |

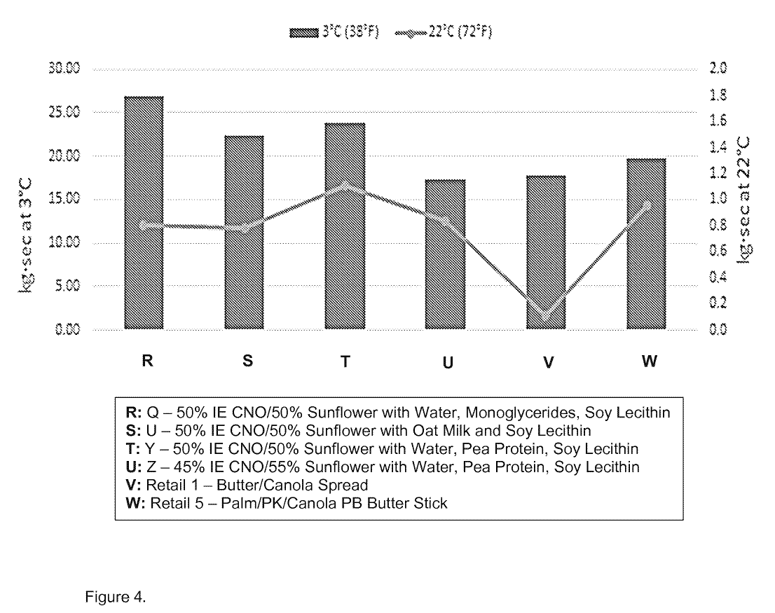

The spreadability of the butter analogues was measured as per Example 1, and are shown in Table 7 below, as well as FIG. 4.

TABLE 7

| Sample | Penetration | Firmness | Spreadability - | Visual Oil |
|---|---|---|---|---|
| (analysed at | (grams of force) - | (kg of | Work of Shear | Separation |
| 22° C.) | average | force) | (kg · sec) | at 22° C. |
| Q | 30.64 | 0.64 | 0.80 | None |
| U | 23.93 | 0.47 | 0.78 | None |
| Y | 37.19 | 0.69 | 1.11 | None |
| Z | 19.15 | 0.54 | 0.84 | Very slight |
| Sample | Penetration | Firmness | Spreadability - | Visual Oil |
| (analysed at | (grams of force) - | (kg of | Work of Shear | Separation |
| 3° C.) | average | force) | (kg · sec) | at 3° C. |
| Q | 1508.02 | 14.54 | 27.00 | None |
| U | 1442.44 | 12.49 | 22.39 | None |
| Y | 1222.01 | 12.95 | 23.81 | None |
| Z | 703 | 9.53 | 17.29 | None |

As can be clearly seen in FIG. 4, Samples Q, U, Y and Z all have comparable spreadability at 3° C. to Retail 1, which is a mixed butter and canola oil spread, and Retail 5, which is a palm and palm kernel-based spread. At 22° C., the spreadability of the Samples Q, U, Y and Z are comparable to Retail 5 and superior to Retail 1. The samples all exhibit essentially no oil separation at 22° C. Sample Z showed very minor visual oil separation at 22° C., which is again considered to be due to the sample being processed using a benchtop ice cream maker, rather than the Margarine and Shortening Pilot Plant.

### Example 4

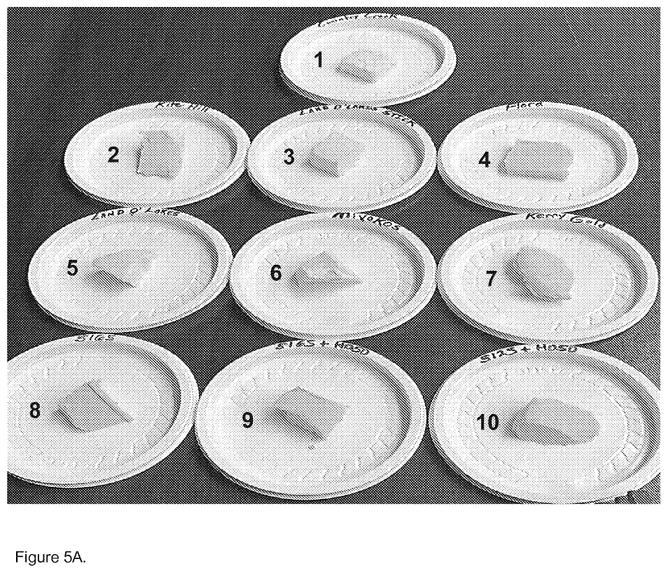

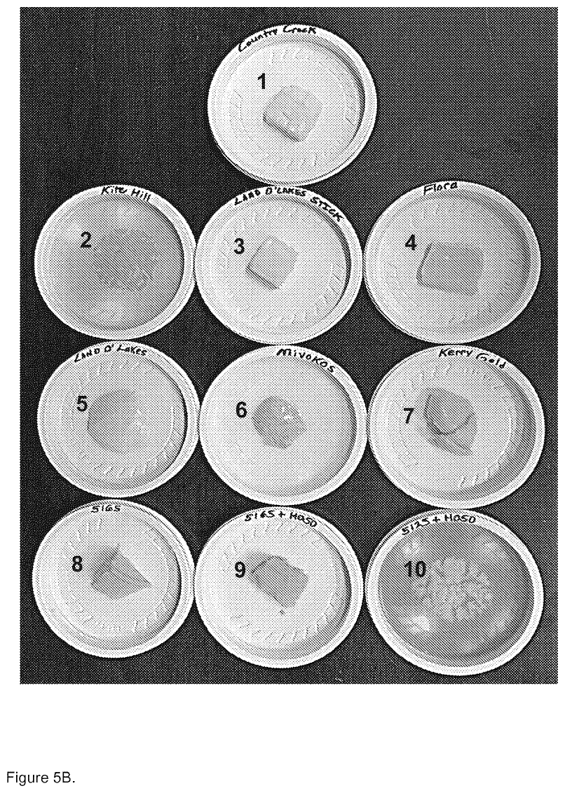

Two butter analogues of the invention and comparable retail butters and butter analogues were kept at 22° C. to observe for oil separation. A comparative analogue using regular coconut oil was also observed as a direct comparison to the butter analogues of the present invention. The retail butter analogues comprised palm oil and palm kernel based fats, as well as coconut oil based fats. FIG. 5A shows the samples at the beginning of the experiment and FIG. 5B shows the samples after having been kept at 22° C.

FIG. 5B shows that real butters (Samples 3 and 7) showed good stability and no oiling out throughout the experiment. It also shows that Samples 1 and 4, which utilise palm oil/palm kernel oil hardstocks, exhibited minimal oiling out. Samples 2, 5 and 6 all showed heavy oiling out and slumping. The butter analogues of the present invention, i.e., Samples 8 and 9, both showed minimal oiling out and good structure retention, just like real butter.

The regular coconut oil comparison, sample 10, showed heavy oiling out and poor structure.

This example clearly shows the problems within the state of the art that the present invention is able to successfully overcome.

1) A dairy analogue composition, the composition comprising a fat phase, an aqueous phase and an emulsifier, wherein the fat phase comprises interesterified coconut oil and wherein the dairy analogue composition is substantially free of hydrogenated fats and oils.

2) A dairy analogue composition according to claim 1, wherein the fat phase comprises interesterified coconut oil mixed with a vegetable oil.

3) A dairy analogue composition according to claim 1, wherein the fat phase comprises from 25% to 100% of interesterified coconut oil mixed with from 0 to 75% of a vegetable oil.

4) A dairy analogue composition according to claim 3, wherein the fat phase comprises from 40% to 90% of interesterified coconut oil mixed with from 10 to 60% of a vegetable oil.

5) A dairy analogue composition according to claim 2, wherein the vegetable oil is selected from rapeseed oil, high oleic rapeseed oil, high erucic acid rapeseed oil, soybean oil, sunflower oil, high oleic sunflower oil, linseed oil, olive oil, corn oil, cottonseed oil, carinata oil, groundnut oil, safflower oil, high oleic safflower oil, peanut oil, avocado oil, rice oil, camelina oil, or any combination thereof.

6) A dairy analogue composition according to claim 5, wherein the vegetable oil is selected from high oleic rapeseed oil, high oleic sunflower oil, high oleic safflower oil, or any combination thereof.

7) A dairy analogue composition according to claim 1, wherein the interesterified coconut oil is fully interesterified.

8) A dairy analogue composition according to claim 1, wherein the interesterified coconut oil is unfractionated coconut oil.

9) A dairy analogue composition according to claim 1, wherein the dairy analogue composition comprises up to 65% by weight of the aqueous phase.

10) A dairy analogue composition according to claim 9, wherein the aqueous phase is present in an amount of 10 to 50% by weight.

11) A dairy analogue composition according to claim 1, wherein the aqueous phase comprises a plant-based milk alternative.

12) A dairy analogue composition according to claim 11, wherein the plant-based milk alternative is derived from cereal, legume, nut, seed, pseudo-cereal, or any combination thereof.

13) A dairy analogue composition according to claim 1, wherein the aqueous phase comprises a plant-derived water.

14) A dairy analogue composition according to claim 13, wherein the plant-derived water is selected from coconut water, maple water, birch water, aloe vera water, cactus water, watermelon water, artichoke water, almond water or combinations thereof.

15) A dairy analogue composition according to claim 1, wherein the dairy analogue composition comprises up to 8% by weight of emulsifier.

16) A dairy analogue composition according to claim 15, wherein the dairy analogue composition comprises from 3 to 5% by weight of emulsifier.

17) A dairy analogue composition according to claim 15, wherein the emulsifier is present in an amount of up to 2% by weight.

18) A dairy analogue composition according to claim 17, wherein the emulsifier is present in an amount of up to 1% by weight.

19) A dairy analogue composition according to claim 1, wherein the emulsifier is selected from a protein, phospholipids, mono- and diglycerides, or any combination thereof.

20) A dairy analogue composition according to claim 1, wherein the composition further comprises one or more colour additives in an amount of 0.001 to 1% by weight of the composition.

21) A dairy analogue composition according to claim 1, wherein the composition further comprises one or more flavourings in an amount of 0.1 to 5% by weight of the composition.

22) A dairy analogue composition according to claim 1, wherein the composition is free of palm and palm kernel oils, and oils derived therefrom.

23) A dairy analogue composition according to claim 1, wherein the diary analogue composition is substantially free of animal protein and/or animal fats.

24) A dairy analogue composition according to claim 1, wherein the dairy analogue composition is substantially free of animal-derived products.

25) A dairy analogue composition according to claim 1, wherein the fat phase has a solid fat content (SFC) N25 of greater than 1 according to ISO 8292-1.

26) A food product comprising a dairy analogue composition according to claim 1.

27) A food product according to claim 26, wherein the product is a butter substitute.

28) A food product according to claim 26, wherein the product is a spread.

29) A food product according to claim 26, wherein the food product is a vegetarian or vegan dairy substitute food product.

30) A food product according to claim 26, wherein the product has a spreadability at 3° C. of from about 5 kg·sec to about 125 kg·sec.

31) A food product according to claim 26, wherein the product has a spreadability at 22° C. of from about 0.3 kg-see to about 16.0 kg·sec.

32) A method of making a dairy analogue composition, comprising addition of a fat phase comprising interesterified coconut oil and a blending vegetable oil, the blending vegetable oil being present in an amount of up to 65% by weight of the fat phase and wherein the fat phase is substantially free of hydrogenated oils, more preferably, the fat phase is free of hydrogenated oils.

33) The method according to claim 32, further comprising using the dairy analogue composition in a food product.

34) The method according to claim 32, where the fat phase is free of palm oil, palm kernel oil, and oils derived therefrom.

35) A method of preparing the dairy analogue composition of claim 1, wherein the method comprises mixing a fat phase comprising interesterified coconut oil, an aqueous phase and an emulsifier.

36) The method of claim 35, wherein the interesterified coconut oil is obtained by chemical interesterification.

37) The method of claim 35, wherein the interesterified coconut oil is obtained by enzymatic interesterification.
